(19) United States
(12) Patent Application Publication
(10) Pub. No.: US 2007/0209187 A1
(43) Pub. Date: Sep. 13, 2007

(54) Device For Assembling A Shield Onto Tank, Shield, Assembly Method And Tank

(75) Inventors: Olivier Buffard, La Baconniere (FR); Olivier Kunstmann, Argentre (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: INERGY AUTO. SYSTEMS RESEARCH (SOCIETE ANONYME), Brussels (BE)

(21) Appl. No.: 10/583,101

(22) PCT Filed: Dec. 16, 2004
(86) PCT No.: PCT/EP04/53540

§ 371 Date: Apr. 10, 2007

(30) Foreign Application Priority Data
Dec. 17, 2003 (FR) 03.14797
Jul. 15, 2004 (FR) 04.07843

(51) Int. Cl. B60K 15/03

(52) U.S. Cl. 29/445; 180/69.4; 220/562; 29/405; 29/428

(57) ABSTRACT

A device for assembling a shield containing at least one hole onto a tank, a shield intended for such a device, an assembly method using the device, and a tank including the device. The device includes a base configured to be firmly attached to a wall of the tank, and a head used for fixing the shield, the head including a groove whose lower and upper lateral surfaces intersect an axis of the device substantially normal to the wall of the tank, the groove being used such that the edge of the hole in the shield slides into the groove. The device also includes a non-return stub that emerges from the outer surface of the device and prevents detachment of the shield from the tank.

The present invention relates to a device for assembling a shield onto a tank. It also relates to a shield intended for this device and a method of assembly using this device. It furthermore relates to a tank including this device.

In motor vehicles, the exhaust system which runs from the engine compartment to the rear of the vehicle generally passes under the fuel tank. When the engine is running, all of the components of the exhaust system (silencers, pipes, etc.) are traversed by hot exhaust gasses which transmit to the walls of the components the heat necessary to raise their wall temperature up to 600° C. (or even higher for certain vehicles and depending on operating conditions). These components are therefore large sources of heat, radiating into their direct environment. Considering the proximity of the fuel tank with respect to these components, it is known to place a heat shield (manufactured for example from corrugated aluminium or from aluminized steel) between the exhaust system and the tank in order to protect the latter from any damage. The heat shield in fact makes it possible to lower the temperature at the level of the tank to about 80° C.

Other types of shield can also be fixed onto the tank. These are for example air-deflector shields intended to improve the deflection of the ambient air around the tank in particular when the vehicle is moving.

It is known in the prior art, in particular from the patents U.S. Pat. No. 4,909,530 and U.S. Pat. No. 4,930,811 to fix a heat shield between the tank and the exhaust system, the heat shield being fixed to the chassis of the vehicle by screws and not directly onto the tank. In the patent U.S. Pat. No. 5,193,262 a multi-part fixing device is divulged of which one element comprising pins is directly imbedded in the wall of the tank just after its manufacture and before it has cooled and another element comprising a bolt is slipped into a housing in the first element. Holes formed in the shield are fitted onto the bolts and are then locked by screwing a nut on the bolt.

The existing devices have either the disadvantage of being multi-part, of complex structure and not very economical, or of not allowing the fixing of the shield directly onto the tank. Now, the space available under the body of the vehicle and the sometimes complex shapes of the tank leave only a few possibilities of inserting a shield. The purpose of the present invention is to provide a simple and optimal solution to the disadvantages described above whilst facilitating the assembly and the automation of the latter.

For this purpose, the invention relates to a device for assembling a shield containing at least one hole onto a tank, comprising:
a) a base intended to be firmly attached to the wall of the tank
b) a head used for fixing the shield, this head comprising a groove whose upper and lower lateral surfaces intersect an axis of the device substantially normal to the wall of the tank the edge of the hole in the shield being slipped into the groove,
c) a non-return stub which emerges from the outer surface of the device and prevents the detachment of the shield from the tank.

The term “shield” refers to any shaped plate.

In particular, in the case of heat shields, the shield consists of one or more constituent materials which provide the heat shield with the property of reflecting the heat emitted by a source located on one side of the heat shield and of acting as a barrier between the heat source and the tank.

In the particular case of air-deflector shields, the shape of the shield is defined such that the ambient air which flows around the latter is deflected when the tank to which the shield is fixed is moving.

The term “tank” is understood to denote a chamber that is closed and of various shapes. The tank can be a gas tank, a liquid tank or a tank designed to contain both a gas and a liquid. Preferably, it is a liquid tank or a tank for a liquid also containing a gaseous phase. In an even more preferred manner, the tank is a fuel tank for motor vehicles.

The device according to the invention is generally formed by a base whose outer surface is totally or partially truncated cone-shaped, cylindrical or any combination of these two geometries and which has, if necessary, a profile adapted for firm attachment to the tank. The axis normal to the wall of the tank at the place of attachment of the base to the wall of the tank is substantially aligned with the axis of revolution of the outer surface of the base.

This base can be hollow or solid.

The device furthermore comprises a groove which is preferably circumferential and whose lower and upper lateral surfaces intersect the axis of the device. In the rest of the text, the term “head” of the device will be used to refer to the part of the device comprising the groove and used for attaching the shield.

The device also comprises an outer non-return stub. This non-return stub preferably forms part of the head and emerges from the outer surface of the device. One part of the stub is substantially parallel with the outer surface of the device and another part is substantially perpendicular to it.

The non-return stub is most often sized such that its profile closely fits that of the associated hole in the shield. In general, the surface profile corresponds to a portion of the contour of the associated hole in the shield. A preferred case of profile surface corresponds to that of a non-return stop whose shape is formed at the periphery of the hole in the shield. In this case the non-return stub cooperates with the non-return stop formed at the periphery of the associated hole in the shield.

Alternatively, the non-return stub can be flexible and can be displaced during the attachment of the shield onto the tank in order to come to bear in a non-permanent manner against the edge of the hole.

In a preferred embodiment of the invention, the head of each assembly device on the tank furthermore comprises an orifice into which a fastener can be inserted. In this case, the shield is assembled onto the tank by means of fasteners which traverse each hole in the shield and are inserted in the orifice of the corresponding assembly device. In fact, it can happen that the attachment device becomes damaged and no longer allows the shield to be attached to it or that the profile of the holes formed in the shield does not correspond to that of the head of the attachment device. In this case, the fastener makes it possible to attach the shield onto the head of the attachment devices simply and effectively.

It can also happen that during the lifetime of the vehicle it is desired to assemble onto the tank a shield that is not adapted to the assembly device according to the invention. In this special case, the use of fasteners allows the assembly device to be used in a another way.

According to the invention, the device in question is made, for example, from plastic and, in a preferred manner, by injection moulding. When it consists of two parts, the first part, for example the head of the device, is injection moulded in a first mould and then, in a second stage, this part is overmoulded by the material forming the other part.

The term “plastic” is understood to be any synthetic polymeric, thermoplastic or thermosetting material which is in the solid state in the ambient conditions, as well as mixtures of at least two of these materials.

The device preferably consists of at least one thermoplastic material.

The device preferably comprises at least two parts.

In an even more preferred way, one part of the device is made of high density polyethylene (HDPE) in order to allow firm attachment by welding to the tank, whose wall generally has an outer surface consisting of HDPE, whilst the other part is made of polyamide (PA).

The device can thus comprise a base made of HDPE and a head made of PA if it consists of two parts. In order to assemble the two parts it is possible, for example, to overmould the part made of HDPE (for example the base) onto the part made of PA (for example the head) since the fusion temperature of HDPE is lower that that of PA and this therefore prevents melting the part made of PA.

Any other assembly technique known to those skilled in the art can be used for assembling the parts of the device according to the invention.

Several devices such as considered in the invention can be used for assembling the shield onto the tank.

In the particular case of heat shields, once the assembly is completed, a layer of air is delimited between the heat shield and the tank: it acts as a heat insulator, complementary to the effect of the heat shield itself.

The invention also relates to a shield previously pierced with holes, the amount of which is at least equivalent to that of the devices on the tank, and whose shape is adapted such that it fits as well as possible into the space available between the tank and the components of the exhaust system which it protects the tank from. The shape of the holes in the shield is designed such that it is adapted to the device for assembling the shield onto the tank: in this instance the contour of each hole can exhibit a narrowing, which delimits in the hole two parts with different areas. The part with the biggest area advantageously has a shape which includes that of the head of the device whilst the part with the smallest area preferably has a shape that makes it possible to lodge the groove of the device during the assembly of the shield onto the tank.

The invention also relates to a method of assembling the shield onto the tank. The shield is assembled onto the tank in the following way: firstly, the base of each device is firmly attached to the wall of the tank. Then the holes of the shield are positioned with respect to the devices of the tank in such a way as to make a device on the tank correspond with a hole in the shield. Then the shield is assembled onto the tank by a two-stage movement: firstly by displacing the shield in a direction normal to the wall of the tank and making the head of each device pass through the biggest of the two parts of the hole on the shield which corresponds to it and then by sliding the shield in a direction parallel with the wall of the tank in such a way that the head of each device becomes lodged in the part of the hole whose section is the smallest and in such a way that the groove of each device cooperates with the edge defined by the smallest part of the hole. Finally, the non-return stub comes to bear against the edge of the hole in its part with the biggest section in such a way that the groove of each device does not become detached from the edge defined by the smallest part of the hole. The contact between the non-return stub and the edge of the hole is not necessarily permanent, in particular when a dimensional clearance has been provided between the two elements. This dimensional clearance allows a small movement of the shield with respect to its fixing points, a movement which is useful in the case when a sudden movement of the tank would apply stress to the fixing of the shield onto the tank.

In the method described above, the firm attachment of the base of each device to the wall of the tank by welding is preferred.

The invention also relates to a tank comprising either at least one device for assembling a shield onto a tank, or a shield as previously described or such a shield assembled onto the tank by one of the methods described above.

The application of the invention to a fuel tank for motor vehicles has given good results.

The term “motor vehicles” refers to vehicles driven by a heat engine such as lorries, motor cars and motorcycles.

The following figures are given for the purpose of illustrating the invention, without intending to restrict its scope.

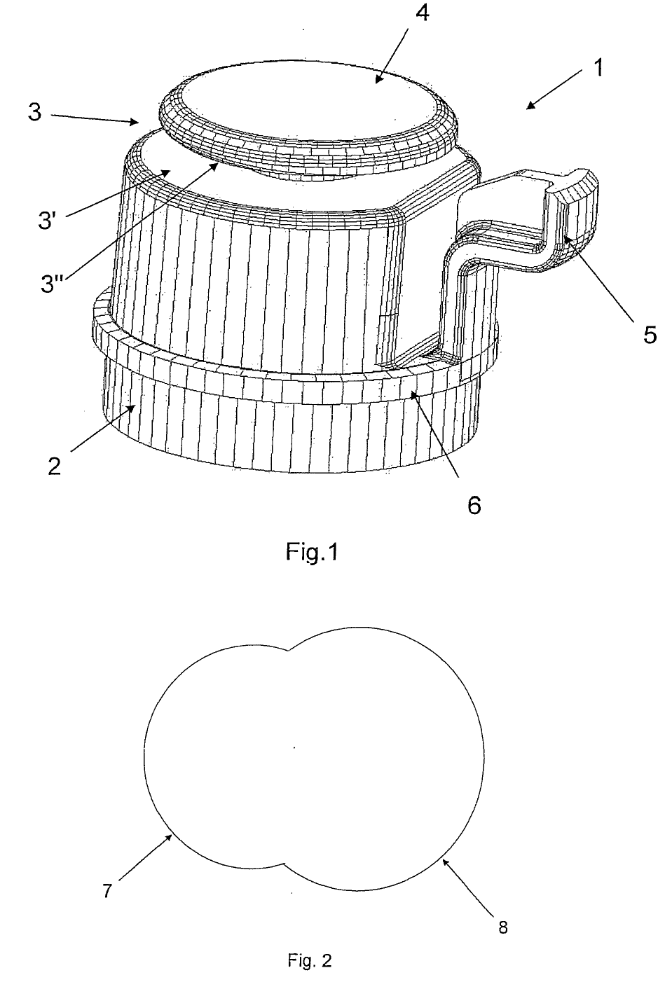

FIG. 1 is a three-dimensional view of a device (1) in which is shown the base (2), the groove (3) (with its lower (3′) and upper (3″) lateral surfaces) and the head (4) of the device (1) as well as the non-return stub (5) and a protrusion (6).

FIG. 2 represents a hole whose contour has a narrowing, thus dividing the hole into two parts with different areas: a large area (8) whose shape includes that of the head (4) of the device (1) and a smaller area (7) in with the groove (3) will be lodged when the shield (10) will have been assembled onto the tank.

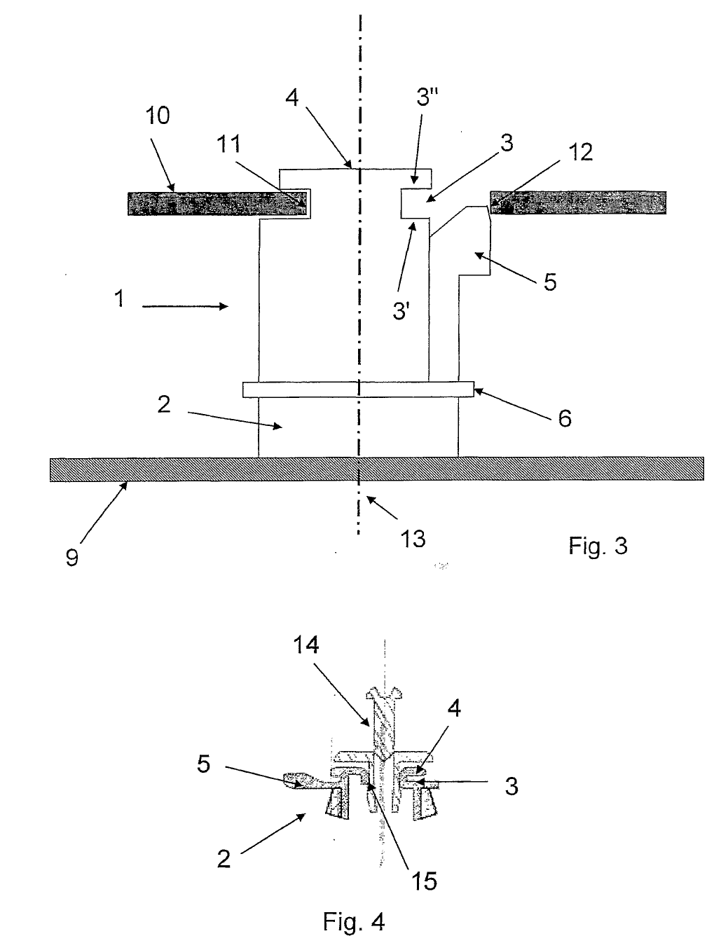

FIG. 3 shows the shield (10) when it is assembled onto the device (1) in a cross-section containing the axis (13) of the device (1) and passing through the non-return stub (5). The axis (13) corresponds to the axis normal to the wall (9) of the tank and which traverses the device (1) from the base (2) to the head (4). The axis (13) is intersected by the lower (3′) and upper (3″) lateral surfaces of the groove (3). On the one hand, the base (2) is firmly connected to the wall (9) of the tank. On the other hand, the shield (10) is assembled onto the device (1) in such a way that the edge (11) of a hole in the shield (10) (having a shape similar to the one shown in FIG. 2) is lodged in the groove (3) and that the non-return stub (5) is bearing against the edge (12) of the same hole in the shield (10) [but diametrically opposite to the edge (11)], thus preventing the detachment of the shield (10) from the device (1).

FIG. 4 shows a fixing device without a shield, in which the head (4) is overmoulded onto the base (2) and comprises an orifice (15). A fastener (14) is inserted in the orifice (15).

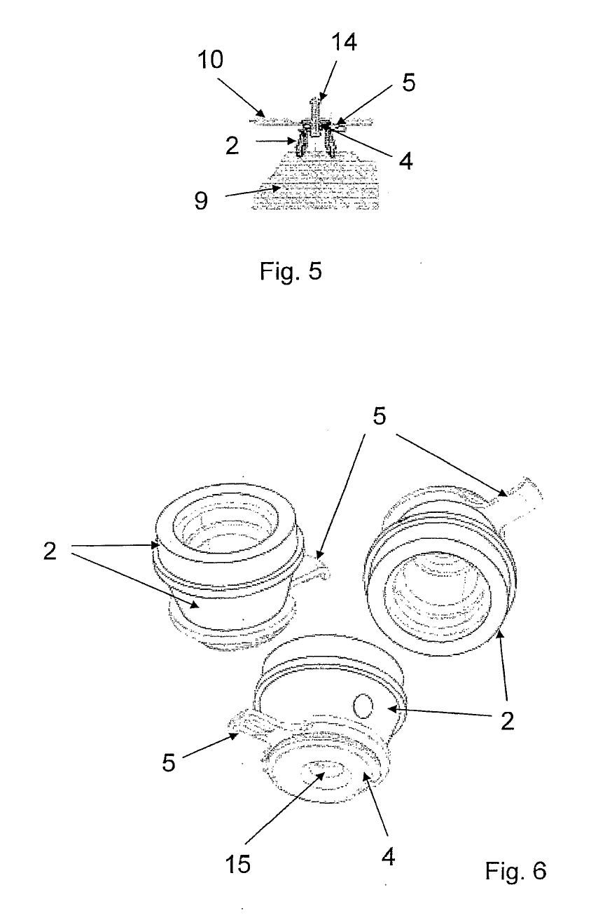

FIG. 5 shows the situation where the shield (10) is fixed on the device comprising the base (2) and the head (4) by the intermediary of the fastener (14).

FIG. 6 shows three different views of a device (1) whose head (4) has an orifice (15) for the insertion therein of a fastener. The base (2) of this device (1) is hollow.

1-10. (canceled)

11. A device for assembling a shield containing at least one hole onto a tank, comprising:
a) a base configured to be attached to a wall of the tank;
b) a head used for fixing the shield, the head including a groove whose upper and lower lateral surfaces intersect an axis of the device substantially normal to the wall of the tank, an edge of the hole in the shield being slipped into the groove; and
c) a non-return stub that emerges from an outer surface of the device and prevents detachment of the shield from the tank.

12. The device according to claim 11, wherein the head further includes an orifice.

13. The device according to claim 11, the device being made from at least one thermoplastic material.

14. The device according to claim 11, the device comprising at least first and second parts.

15. The device according to claim 14, wherein the first part is made of high density polyethylene (HDPE) and the second part is made of polyamide (PA).

16. A shield intended for a device according to claim 11, wherein the shield has at least one hole whose contour exhibits a narrowing delimiting in the hole two parts having different areas.

17. The shield according to claim 16, wherein the hole is provided with a non-return stop.

18. A method of assembling a shield making use of at least one device according to claim 11, according to which:
a) the base of each device is attached to the wall of the tank;
b) the shield is positioned with respect to the tank so as to make each device on the tank correspond with a hole in the shield;
c) the shield is fixed to the tank by a two-stage movement: firstly by displaying the shield in a direction normal to the wall of the tank and making the head of each device pass through a biggest of the two parts of the hole which corresponds to the head, such that the groove of each device cooperates with an edge defined by the biggest part of the hole and then by sliding the shield in a direction parallel with the wall of the tank such that the head of each device becomes lodged in the part of the hole whose section is the smallest; and
d) the non-return stub comes to bear in a non-permanent manner against the edge of the hole in its part with the biggest section such that the groove of each device does not become detached from the edge defined by the smallest part of the hole.

19. The method of assembling recording claim 18, according to which the base of each device is attached to the wall of the tank by welding.

20. A fuel tank for motor vehicles comprising at least one device according to claim 11.
